(19) United States
(12) Patent Application Publication
(10) Pub. No.: US 2026/0211441 A1
(43) Pub. Date: Jul. 23, 2026

(54) LOW-DROPOUT REGULATOR WITH AN IMPROVED POWER SUPPLY REJECTION RATIO USING FEED-FORWARD OR BULK POWER SUPPLY RIPPLE INJECTION

(71) Applicants: Infineon Technologies AG, Neubiberg (DE); Universita degli Studi di Milano-Bicocca, Milano (IT)

(72) Inventors: Francesco Spreafico, Lecco (IT); Andrea Baschirotto, Tortona (IT); Richard Gaggl, Pörtschach (AT); Luca Sant, Cassacco (IT)

(21) Appl. No.: 19/028,583

(22) Filed: Jan. 17, 2025

(51) Int. Cl. G05F 1/595; G05F 1/575

(52) U.S. Cl. CPC G05F 1/595; G05F 1/575

(57) ABSTRACT

A low drop-out (LDO) voltage regulator circuit includes an LDO voltage regulator including a pass device coupled to a power supply voltage, wherein the pass device includes a bulk node; an amplifier having an input coupled to the power supply voltage; a first capacitor coupled between an output of the amplifier and the bulk node of the pass device; and a first resistor coupled between the bulk node of the pass device and the power supply voltage having a low ohmic value in a first operating mode and a high ohmic value in a second operating mode.

### TECHNICAL FIELD

The present invention relates generally to a low-dropout (LDO) regulator with an improved power supply rejection ratio (PSRR) using feed-forward or bulk power supply ripple injection and, in particular embodiments, to a corresponding method.

### BACKGROUND

Power supply rejection ratio (PSRR), wherein PSRR is defined as being equal to the output voltage divided by the input voltage, and wherein zero is the ideal value (or minus infinity on the decibel scale. PSRR is a key feature of analog LDO voltage regulators. Indeed, critical high-precision and low-noise analog building blocks that require a clean and stable supply voltage from the LDO regulator for proper operation. A Flipped-Voltage-Follower (FVF)-based topology is generally a suitable prior art solution since it provides high PSRR and short recovery times of its output potential. In particular, the internal dominant pole structures present high loop gain, reduced area usage, no external bulky capacitor and little current consumption. However, the PSRR of the FVF LDO regulators starts to degrade at frequencies greater than their loop gain dominant pole. This effect is worsened by the adoption of 55 nm/28 nm/22 nm technologies and the corresponding low 1.2 V supply voltage. In fact, increased parasitic effects, reduced transistor output impedance, and subthreshold operations due to the low supply voltage further enhance the reduction in PSRR.

Moreover, although high PSRR into the audio band can usually be guaranteed by conventional LDO solutions, their PSRR performances typically rapidly degrade for higher frequencies. Therefore, external decoupling capacitors are usually placed on the printed circuit board (PCB) of the FVF LDO regulator to filter out undesired ripple on the supply rail. However, conventional decoupling capacitors are usually only effective starting from frequencies in the range of a few MHz. Shielding the supply voltage down to the audio band would require capacitors with huge footprints and high costs. This limits the products minimum feature size and increases the costs.

The classical solution to such problems consists in drastically increasing the LDO regulator current consumption to shift all the poles to higher frequencies and extend its bandwidth (BW). However, this is not always feasible due to limited total current budget available. While other prior art solutions improve the PSRR after the first pole of the loop gain, they typically undesirably increase total current consumption, are usually effective with load currents in the range of a few mA, and they have never been applied to an FVF-based LDO regulator. In addition, current existing prior art solutions present considerable circuit complexity, making their designs less robust and more prone to fail.

### SUMMARY

According to an embodiment, a low drop-out (LDO) voltage regulator circuit comprises an LDO voltage regulator comprising a pass device coupled to a power supply voltage, wherein the pass device comprises a bulk node; an amplifier having an input coupled to the power supply voltage; a first capacitor coupled between an output of the amplifier and the bulk node of the pass device; and a first resistor coupled between the bulk node of the pass device and the power supply voltage having a low ohmic value in a first operating mode and a high ohmic value in a second operating mode.

According to an embodiment a low drop-out (LDO) voltage regulator circuit comprises an LDO voltage regulator comprising a pass device coupled to a power supply voltage, wherein the pass device comprises a bulk node; an amplifier having an input coupled to the power supply voltage; a first capacitor coupled between an output of the amplifier and a current path node of the pass device; and a second capacitor coupled between the output of the amplifier and the power supply voltage.

According to an embodiment, a method for reducing a power supply rejection ratio (PSRR) of a low-dropout (LDO) voltage regulator including a flipped voltage follower (FVF) stage comprises AC injecting an amplified replica of a power supply ripple signal into a node of the FVF stage.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic diagram of a folded FVF-based LDO regulator circuit according to the prior art;

FIG. 2A is a schematic diagram of a folded FVF-based LDO regulator circuit with bulk node power supply ripple injection according to an embodiment.

FIG. 2B is a schematic diagram of the folded FVF-based LDO regulator circuit of FIG. 2A showing further details of a power supply ripple injection amplifier according to an embodiment;

FIG. 3A is a schematic diagram of a folded FVF-based LDO regulator circuit with feed-forward power supply ripple injection according to an embodiment.

FIG. 3B is a schematic diagram of the folded FVF-based LDO regulator circuits of FIG. 2A and FIG. 3A showing further details of a power supply ripple injection amplifier according to an embodiment; and

FIG. 3C is a schematic diagram of the folded FVF-based LDO regulator circuit of FIG. 3A showing further details of a power supply ripple injection amplifier according to another embodiment.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In the following detailed description, reference is made to the accompanying drawings, which form a part hereof and in which are shown by way of illustrations specific embodiments in which the invention may be practiced. It is to be understood that other embodiments may be utilized and structural or logical changes may be made without departing from the scope of the present invention. For example, features illustrated or described for one embodiment can be used on or in conjunction with other embodiments to yield yet a further embodiment. It is intended that the present invention includes such modifications and variations. The examples are described using specific language, which should not be construed as limiting the scope of the appending claims. The drawings are not scaled and are for illustrative purposes only. For clarity, the same or similar elements have been designated by corresponding references in the different drawings if not stated otherwise.

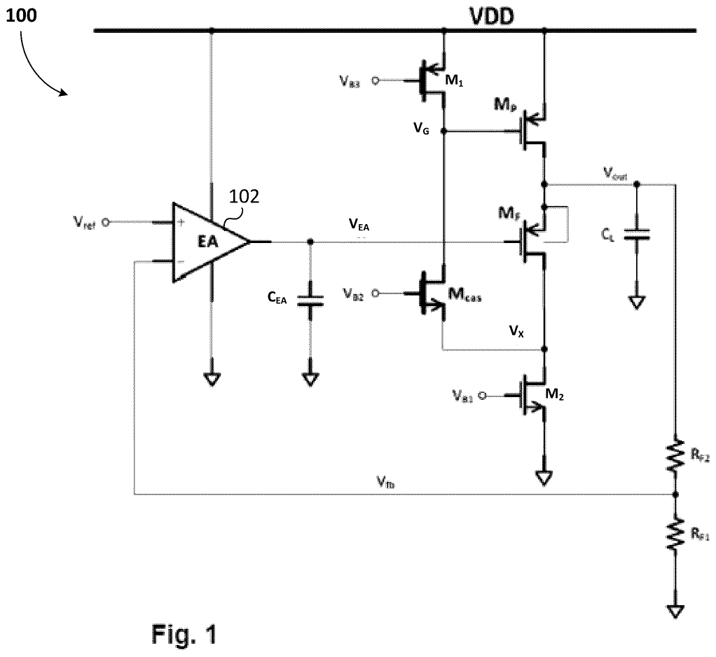

FIG. 1 is a schematic diagram of a folded FVF-based LDO regulator circuit 100 according to the prior art. Regulator circuit 100 comprises an error amplifier 102 having power terminals coupled between the V_{DD} power supply and ground, a positive input for receiving a V_{REF} reference voltage, a negative input coupled to the V_{FB} node, and an output coupled to the V_{EA} node. Capacitor C_{EA} is coupled between the V_{EA} node and ground. PMOS follower transistor MF includes a gate coupled to the V_{EA} node, a source coupled to the V_{OUT} node, and a drain coupled to the V_{X} node. PMOS pass transistor MP includes a gate coupled to the V_{G} node, a source coupled to the V_{DD} power supply, and a drain coupled to the V_{OUT} node. NMOS cascode transistor M_{CAS} includes a gate coupled to the V_{B2} node, a drain coupled to the V_{G} node, and a source coupled to the V_{X} node. PMOS current biasing transistor M₁ includes a gate coupled to the V_{B3} node, a source coupled to the V_{DD} power supply, and a source coupled to the V_{G} node. NMOS current biasing transistor M₂ includes a gate coupled to the V_{B1} node, a drain coupled to the V_{X} node, and a source coupled to ground. Capacitor C_{L} is coupled between the V_{OUT} node and ground. Feedback resistor R_{F1} is coupled between the V_{FB} node and ground, and feedback resistor R_{F2} is coupled between the V_{OUT} node and the V_{FB} node.

In operation, the folded FVF-based LDO regulator circuit 100 generates an output voltage that is a function of the input V_{REF} voltage and a ratio of the feedback resistors. As previously discussed, the output voltage is substantially immune to variations in the power supply voltage at low frequencies. The PSRR performance of regulator circuit 100 is provided by its high loop gain. However, the limited current budget of battery-operated systems, the considerably large parasitic effects of 55 nm/28 nm/22 nm technology and the required high DC gain (to obtain the high low-frequency PSRR) result in shifting the LDO dominant pole to a low frequency value. Therefore, the PSRR decreases for frequencies higher than the dominant pole and PSRR degradation becomes critical before conventional external decoupling capacitors begin filtering the power supply voltage. To provide high PSRR values over the band of interest and above, up to few MHz, a considerable increase of current consumption is usually needed. Bandwidth is proportional to the gm of a transistor, but gm~√I. Nevertheless, the intrinsic gain A=gm/gds of the transistor must be kept high to provide the desired low frequency performance, but gm/gds~1/√I. The intrinsic gain is even lower in smaller feature size technologies such as 55 nm, 28 nm or 22 nm CMOS.

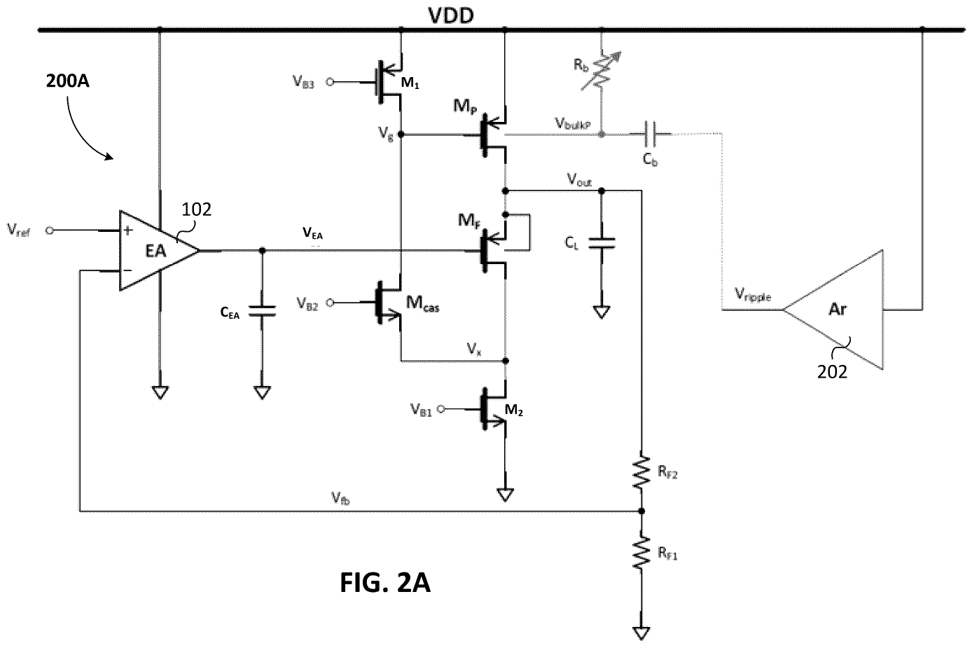

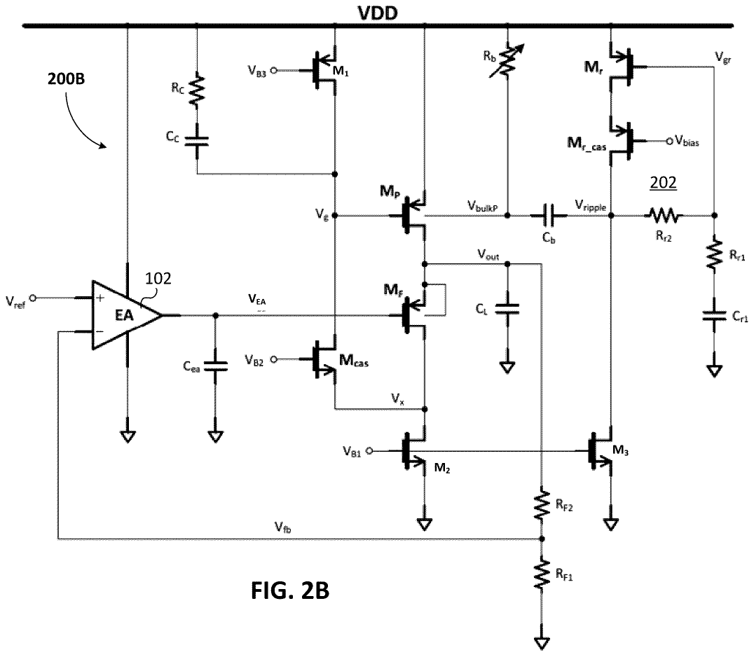

FIG. 2A is a schematic diagram of a folded FVF-based LDO regulator circuit 200A with bulk node power supply ripple injection according to an embodiment. The bulk node power supply ripple injection is provided by amplifier 202, having a gain value of Ar. The gain value is carefully chosen to provide a substantial increase in the PSRR at higher frequencies. The input of amplifier 202 is thus coupled to the V_{DD} power supply and the output of amplifier 202 is coupled to the V_{RIPPLE} node. Capacitor C_{B} is coupled between the V_{RIPPLE} node and the bulk node V_{BULKP} of pass transistor M_{P}. A variable resistor R_{B} is coupled between the V_{BULKP} node and the V_{DD} power supply. The operation of variable resistor R_{B} and other operational details of regulator circuit 200A are described in further detail below.

FIG. 2B is a schematic diagram of a folded FVF-based LDO regulator circuit 200B similar to the regulator circuit 200A of FIG. 2A, but showing further details of the power supply ripple injection amplifier 202 according to an embodiment.

For example, amplifier 202 is shown at the schematic level including a PMOS transistor M_{R} having a gate coupled to the V_{GR} node, a source coupled to the V_{DD} power supply, and a drain; and a PMOS transistor M_{R_CAS} having a gate coupled to the V_{BIAS} node, a source coupled to the drain of the M_{R} transistor, and a drain coupled to the V_{RIPPLE} node. Amplifier 202 also includes resistor R_{R2} coupled between the V_{RIPPLE} node and the V_{GR} node, and resistor R_{R1} and capacitor C_{R1} in series connection coupled between the V_{GR} node and ground.

Regulator circuit 200B also includes resistor R_{C} and capacitor C_{C} in series connection coupled between the V_{DD} power supply and the V_{G} node. The effect of resistor R_{C} and capacitor C_{C} with respect to the PSRR is explained in detail below.

In an embodiment, the single-stage amplifier 202 reads and amplifies the supply ripple. The amplified ripple signal is then injected to the bulk-terminal of the LDO pass device M_{P} by AC-coupling capacitor C_{B}. The pass device M_{P} connects the V_{DD} supply-rail (input) and output-voltage V_{OUT} of regulator circuit 200B. The bulk node signal injection allows a reduction of the direct transmission of undesired ripple on the V_{DD} supply rail. This significantly improves the PSRR at high frequencies without adding too much complexity to the LDO regulator circuit 200B, with a limited increase of current consumption. Regulator circuit 200B maintains a high PSRR with low load currents (in the range of dozens or hundreds of μA),in contrast with current existing and published prior art solutions.

In operation, regulator circuit 200B improves the PSRR for frequencies higher than the LDO dominant pole (and PSRR dominant zero) with just 1.58 μA of additional current in an embodiment. The following equations describe are related to the PSRR of regulator circuit 200B and the ideal gain value Ar, wherein “gmb” represents the body transconductance, sometimes called the bulk transconductance or substrate transconductance.

PSRR=[(gm_{P}*Cgd_{P}/C_{C})+gds_{P})*Zₒᵤₜ],

where gm_{P}, gds_{P}, Cgd_{P}, C_{C} and Zₒᵤₜ are the pass device (MP) transconductance, transimpedance, gate-drain capacitor value, the compensating capacitor value and the LDO output impedance, respectively. Additional circuitry in FIG. 2B adds the contribution of gmb_{P}*vsb (vsb=source-bulk potential, gmb_{P}=MP body transconductance) to the direct signal transmission, leading to:

PSRR=[(gm_{P}*Cgd_{P}/C_{C})+gds_{P}+gmb_{P}(1−vb/vdd)] Zₒᵤₜ=[(gm_{P}*Cgd_{P}/C_{C})+gds_{P}+gmb_{P}(1−Ar)] Zₒᵤₜ, [1]
with Ar the closed-loop gain of amplifier 202. Therefore, the term in square brackets can be cancelled out with a proper choice of Ar and the PSRR can then be improved. Moreover, the bulk injection embodiment described above has little influence on the LDO stability.

Setting the term in square brackets to zero yields:

Ar=1+(gmP/gmbP)*(CgdP/CC)+(gdsP*gmbP)

Thus, the PSRR can be heavily reduced with the proper choice of the gain value Ar.

Thus, a high bandwidth cascoded common source amplifier 202 is implemented (including transistors M_{R} and M_{R_CAS}) as previously described. Amplifier 202 is implemented with a circuit topology that allows maximization of the gm and the bandwidth for a given current. The cascode transistor M_{R_CAS} is added to increase the gain. The V_{DD} supply ripple is coupled to the positive input of amplifier 202, which is the source of transistor M_{R}. A negative feedback network (resistor R_{R2} and resistor R_{R1}) is provided to properly adjust the closed-loop gain Ar, which is needed to properly cancel out the term in squared parenthesis in Equation [1]. A capacitor Cr1 is also added in series with resistor Rr1 to avoid DC current to flow into the feedback network. This allows a reduction in the values of resistor Rr1 and resistor Rr2 and reduces area and power dissipation. The amplified signal is then injected into the FVF output stage by means of an AC-coupling capacitor (C_{B}). In particular, the injection takes place at the bulk node V_{BULKP} of the pass device M_{P}.

In addition, a variable resistor R_{B} is added to regulator circuit 200B as previously described. The resistance of variable resistor R_{B} presents two operating states: a low ohmic one and a high-ohmic one. The former is needed during the start-up phase. In the start-up phase time interval, the value of variable resistor R_{B} is kept in the low ohmic state and a normal operating point is reached by bringing V_{BULKP} up to the DC V_{DD} supply voltage. After the start-up phase, the value of variable resistor R_{B} is brought to the high ohmic state. This creates a low pass filter from the VDD power supply to the V_{BULKP} node and a high pass filter from the V_{RIPPLE} node to the V_{BULKP} node.

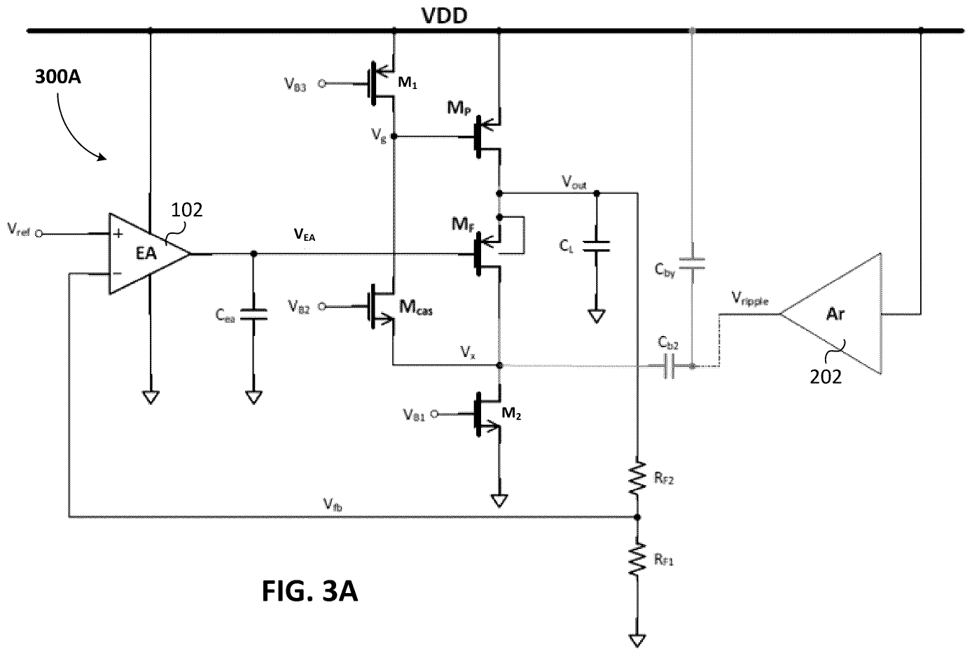

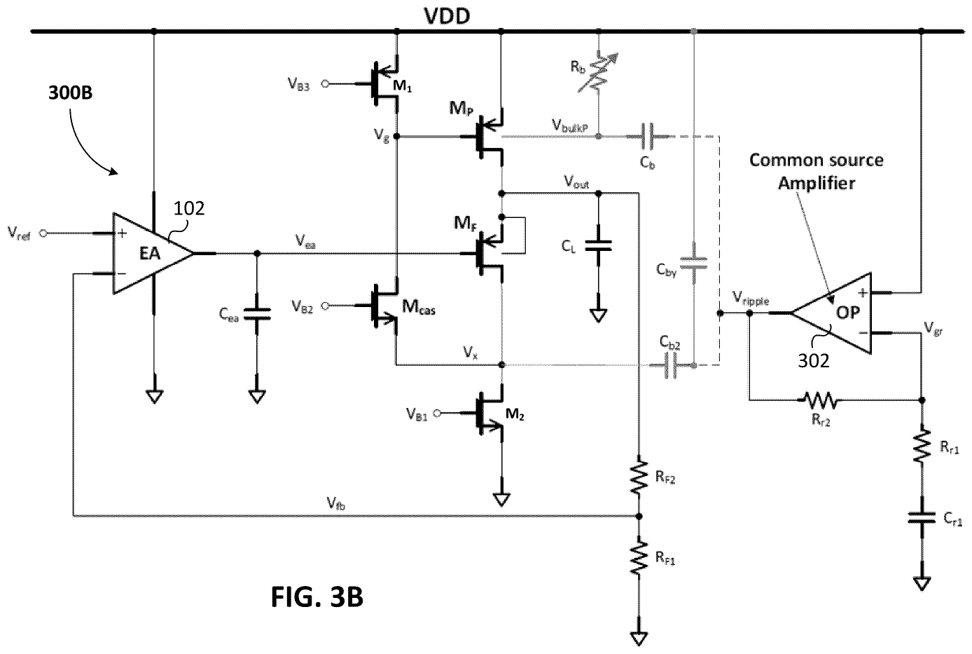

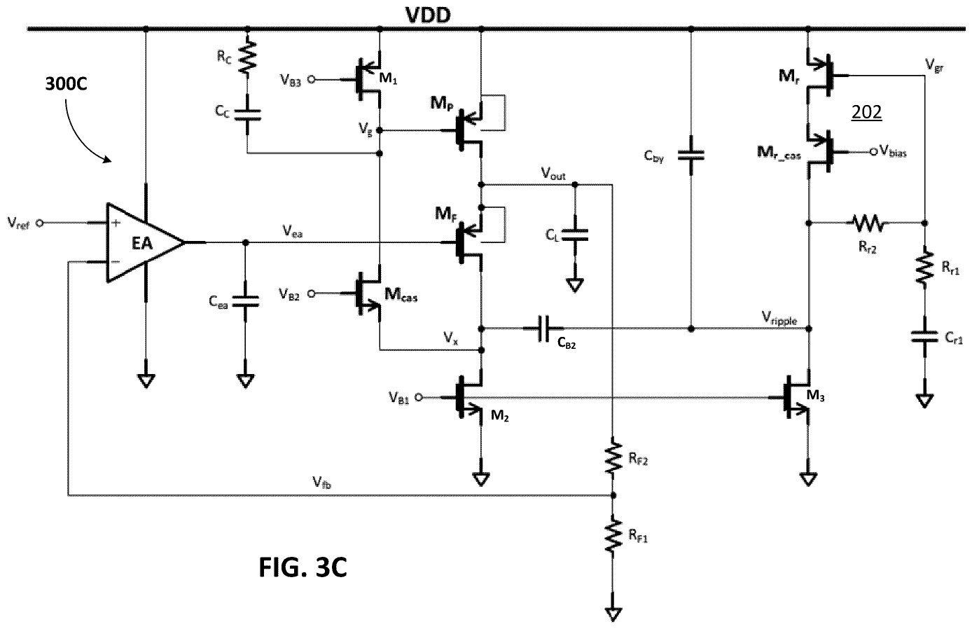

FIG. 3A is a schematic diagram of a folded FVF-based LDO regulator circuit 300A with feed-forward power supply ripple injection according to an embodiment. The feed forward power supply ripple injection is also provided by amplifier 202, having a gain value of Ar, but is injected into a different node of the regulator circuit as well be explained in further detail below. The gain value is again carefully chosen to provide a substantial increase in the PSRR at higher frequencies. The input of amplifier 202 is thus coupled to the V_{DD} power supply and the output of amplifier 202 is coupled to the V_{RIPPLE} node. Capacitor C_{B2} is coupled between the V_{RIPPLE} node and the V_{X} node. Capacitor C_{BY} is coupled between the V_{RIPPLE} node and the V_{DD} power supply. The operation of capacitor C_{B2} and capacitor C_{BY} and other operational details of regulator circuit 300A are described in further detail below.

FIG. 3B is a schematic diagram of the folded FVF-based LDO regulator circuits of FIG. 2A and FIG. 3A showing further details of a power supply ripple injection amplifier 202 according to an embodiment. In an embodiment, amplifier 202 can comprise an operational amplifier 302, wherein the output is coupled to the V_{RIPPLE} node, the positive input is coupled to the V_{DD} power supply, and the negative input is coupled to the V_{GR} node. Resistor R_{R1} and capacitor C_{R1} are in series connection between node V_{GR} and ground. Resistor R_{R2} is coupled between the V_{GR} node and the V_{RIPPLE} node. FIG. 3B further illustrates that the operational amplifier 302 embodiment can be used both with the feed forward embodiment and the bulk node injection embodiment. The dashed lines in FIG. 3B illustrate alternative embodiments, wherein the output of operational amplifier 302 is coupled either to capacitor C_{B}, which is the bulk node injection embodiment, or the junction between capacitor C_{B2} and capacitor C_{BY}, which is the feed forward injection embodiment.

FIG. 3C is a schematic diagram of a folded FVF-based LDO regulator circuit 300C similar to the regulator circuit of FIG. 3A showing further details of a power supply ripple injection amplifier 202 according to another embodiment. Circuit components including resistor R_{C}, capacitor C_{C}, capacitor C_{L}, transistor M₂, transistor M₃, transistor M_{R}, and transistor M_{R_CAS} have all been previously described. It is important to note, however, that regulator circuit 300C uses feed forward injection, wherein the output of amplifier 202 is coupled to the V_{RIPPLE} node, which in this embodiment is the junction between capacitor C_{B2} and capacitor C_{BY}.

In operation, single-stage amplifier 202 reads and amplifies the supply ripple. Then it feeds forward the amplified signal to a proper internal node of the FVF loop by an AC-coupling capacitor C_{B2}. This signal can then reach the gate of the pass device M_{P}, which connects the VDD supply-rail (input) and output voltage of regulator circuit 300C, which is explained in further detail below. The feed forward signal injection reduces a direct transmission of undesired ripple on the supply rail. This significantly improves the PSRR at high frequencies without additional complexity to the LDO regulator circuit 300C, and with a limited increase of current consumption. Regulator circuit 300C effective with low load currents (in the range of dozens or hundreds of μA),in contrast with current existing and published prior art solutions.

Regulator circuit 300C improves the PSRR for frequencies higher than the LDO dominant pole (and PSRR dominant zero) with just 1.28 μA of additional current, as demonstrated by the following equation:

PSRR=[(gm_{P}*Cgd_{P}/C_{C})+gds_{P})*Zout]

where gm_{P}, gds_{P}, Cgd_{P}, C_{C} and Zout are the pass device (M_{P}) transconductance, transimpedance, gate-drain capacitor value, the compensating capacitor value, and the LDO output impedance, respectively. Additional circuitry in FIG. 3C feeds forward the undesired supply ripples (properly amplified) to the gate of the pass device MP. Therefore:

PSRR=[gm_{P} (Cgd_{P}/C_{C}−Ar)+gdsP]*Zout, [2]
with Ar representing the closed-loop gain of amplifier 202 and of the cascode stage of the FVF loop (transistor M_{CAS}). Therefore, the term in squared parenthesis can be cancelled out with a proper choice of Ar and the PSRR can then be improved. Moreover, the feed forward embodiment described above has little influence on the LDO stability.

Setting the term in square brackets to zero yields:

Ar=Cgd_{P}/C_{C}+gds_{P}/gm_{P}

Thus, PSRR as defined can be once again cancelled by a careful selection of the value of the amplifier gain Ar.

The high bandwidth cascoded common source amplifier 202 shown in FIG. 3C has been previously shown and described. The amplified signal at the output of amplifier 202 is injected into the FVF loop at node V_{X} by capacitor C_{B2}, closing the feed-forward path from the supply rail. The V_{X} node is a low impedance node is suitable for current reading and summing. Finally, the amplified signal comes to node V_{G} trough transistor M_{CAS}. In addition, a small bypass capacitor C_{BY} is added. The addition of this capacitor prevents node V_{RIPPLE} to go to AC-ground after the unity-gain-frequency of the amplifier 202. The supply rail ripple is still injected after the unity gain frequency, at which point capacitor C_{BY} becomes an AC-short circuit. The signal injection through capacitor C_{BY} continues through capacitor C_{B2} and the current path of transistor M_{CAS} to node V_{G}.

Example embodiments of the present invention are summarized here. Other embodiments can also be understood from the entirety of the specification and the claims filed herein.

Example 1. According to an embodiment, a low drop-out (LDO) voltage regulator circuit comprises an LDO voltage regulator comprising a pass device coupled to a power supply voltage, wherein the pass device comprises a bulk node; an amplifier having an input coupled to the power supply voltage; a first capacitor coupled between an output of the amplifier and the bulk node of the pass device; and a first resistor coupled between the bulk node of the pass device and the power supply voltage having a low ohmic value in a first operating mode and a high ohmic value in a second operating mode.

Example 2. The LDO voltage regulator circuit of Example 1, wherein a gain of the amplifier is configured to substantially reduce a power supply rejection ratio (PSRR) of a ripple signal of the power supply voltage with respect to an output voltage of the LDO voltage regulator circuit.

Example 3. The LDO voltage regulator circuit of any of the above examples, further comprising a second capacitor and a second resistor in series connection coupled between the pass device and the power supply voltage.

Example 4. The LDO voltage regulator circuit of any of the above examples, wherein the amplifier comprises an operational amplifier in a common source configuration.

Example 5. The LDO voltage regulator circuit of any of the above examples, wherein the operation amplifier comprises a cascode transistor circuit.

Example 6. The LDO voltage regulator circuit of any of the above examples, further comprising a feedback circuit.

Example 7. The LDO voltage regulator circuit of any of the above examples, wherein the feedback circuit comprises a third capacitor and a third resistor in series connection coupled between an inverting input of the operational amplifier and ground; and a fourth resistor coupled between the inverting input of the operational amplifier and the output of the operational amplifier.

Example 8. The LDO voltage regulator circuit of any of the above examples, wherein the LDO voltage regulator comprises a flipped voltage follower (FVF) stage.

Example 9. According to an embodiment, a low drop-out (LDO) voltage regulator circuit comprises an LDO voltage regulator comprising a pass device coupled to a power supply voltage, wherein the pass device comprises a bulk node; an amplifier having an input coupled to the power supply voltage; a first capacitor coupled between an output of the amplifier and a current path node of the pass device; and a second capacitor coupled between the output of the amplifier and the power supply voltage.

Example 10. The LDO voltage regulator circuit of Example 9, wherein a gain of the amplifier is configured to substantially reduce a power supply rejection ratio (PSRR) of a ripple signal of the power supply voltage with respect to an output voltage of the LDO voltage regulator circuit.

Example 11. The LDO voltage regulator circuit of any of the above examples, further comprising a third capacitor and a second resistor in series connection coupled between the pass device and the power supply voltage.

Example 12. The LDO voltage regulator circuit of any of the above examples, wherein the amplifier comprises an operational amplifier in a common source configuration.

Example 13. The LDO voltage regulator circuit of any of the above examples, wherein the operation amplifier comprises a cascode transistor circuit.

Example 14. The LDO voltage regulator circuit of any of the above examples, further comprising a feedback circuit.

Example 15. The LDO voltage regulator circuit of any of the above examples, wherein the feedback circuit comprises a fourth capacitor and a third resistor in series connection coupled between an inverting input of the operational amplifier and ground; and a fourth resistor coupled between the inverting input of the operational amplifier and the output of the operational amplifier.

Example 16. The LDO voltage regulator circuit of any of the above examples, wherein the LDO voltage regulator comprises a flipped voltage follower (FVF) stage.

Example 17. According to an embodiment, a method for reducing a power supply rejection ratio (PSRR) of a low-dropout (LDO) voltage regulator including a flipped voltage follower (FVF) stage, the method comprising AC injecting an amplified replica of a power supply ripple signal into a node of the FVF stage.

Example 18. The method of Example 17, wherein the node comprises a bulk node of a pass device in the FVF stage.

Example 19. The method of any of the above examples, wherein the node comprises a pass device current path node in the FVF stage.

Example 20. The method of any of the above examples, further comprising adjusting an amplitude of the amplified replica of the power supply ripple signal so that the PSRR is substantially reduced.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A low drop-out (LDO) voltage regulator circuit comprising:
an LDO voltage regulator comprising a pass device coupled to a power supply voltage, wherein the pass device comprises a bulk node;
an amplifier having an input coupled to the power supply voltage;
a first capacitor coupled between an output of the amplifier and the bulk node of the pass device; and
a first resistor coupled between the bulk node of the pass device and the power supply voltage having a low ohmic value in a first operating mode and a high ohmic value in a second operating mode.

2. The LDO voltage regulator circuit of claim 1, wherein a gain of the amplifier is configured to substantially reduce a power supply rejection ratio (PSRR) of a ripple signal of the power supply voltage with respect to an output voltage of the LDO voltage regulator circuit.

3. The LDO voltage regulator circuit of claim 1, further comprising a second capacitor and a second resistor in series connection coupled between the pass device and the power supply voltage.

4. The LDO voltage regulator circuit of claim 1, wherein the amplifier comprises an operational amplifier in a common source configuration.

5. The LDO voltage regulator circuit of claim 4, wherein the operation amplifier comprises a cascode transistor circuit.

6. The LDO voltage regulator circuit of claim 4, further comprising a feedback circuit.

7. The LDO voltage regulator circuit of claim 6, wherein the feedback circuit comprises:
a third capacitor and a third resistor in series connection coupled between an inverting input of the operational amplifier and ground; and
a fourth resistor coupled between the inverting input of the operational amplifier and the output of the operational amplifier.

8. The LDO voltage regulator circuit of claim 1, wherein the LDO voltage regulator comprises a flipped voltage follower (FVF) stage.

9. A low drop-out (LDO) voltage regulator circuit comprising:
an LDO voltage regulator comprising a pass device coupled to a power supply voltage, wherein the pass device comprises a bulk node;
an amplifier having an input coupled to the power supply voltage;
a first capacitor coupled between an output of the amplifier and a current path node of the pass device; and
a second capacitor coupled between the output of the amplifier and the power supply voltage.

10. The LDO voltage regulator circuit of claim 9, wherein a gain of the amplifier is configured to substantially reduce a power supply rejection ratio (PSRR) of a ripple signal of the power supply voltage with respect to an output voltage of the LDO voltage regulator circuit.

11. The LDO voltage regulator circuit of claim 9, further comprising a third capacitor and a second resistor in series connection coupled between the pass device and the power supply voltage.

12. The LDO voltage regulator circuit of claim 9, wherein the amplifier comprises an operational amplifier in a common source configuration.

13. The LDO voltage regulator circuit of claim 12, wherein the operation amplifier comprises a cascode transistor circuit.

14. The LDO voltage regulator circuit of claim 12, further comprising a feedback circuit.

15. The LDO voltage regulator circuit of claim 14, wherein the feedback circuit comprises:
a fourth capacitor and a third resistor in series connection coupled between an inverting input of the operational amplifier and ground; and
a fourth resistor coupled between the inverting input of the operational amplifier and the output of the operational amplifier.

16. The LDO voltage regulator circuit of claim 9, wherein the LDO voltage regulator comprises a flipped voltage follower (FVF) stage.

17. A method for reducing a power supply rejection ratio (PSRR) of a low-dropout (LDO) voltage regulator including a flipped voltage follower (FVF) stage, the method comprising AC injecting an amplified replica of a power supply ripple signal into a node of the FVF stage.

18. The method of claim 17, wherein the node comprises a bulk node of a pass device in the FVF stage.

19. The method of claim 17, wherein the node comprises a pass device current path node in the FVF stage.

20. The method of claim 17, further comprising adjusting an amplitude of the amplified replica of the power supply ripple signal so that the PSRR is substantially reduced.
